(19) United States
(12) Patent Application Publication
(10) Pub. No.: US 2018/0189914 A1
(43) Pub. Date: Jul. 5, 2018

(54) SYSTEMS AND METHODS FOR WEB-BASED HEALTH AND SECURITY MANAGEMENT

(71) Applicant: AEA International Holdings Pte. Ltd., Singapore (SG)

(72) Inventors: Myles Christopher DRUCKMAN, Santa Monica, CA (US); Grant Jeffery, Jersey City, NJ (US); Timothy Michael Daniel, Philadelphia, PA (US); Christopher Trueba Gonzales, Chandler, AZ (US)

(21) Appl. No.: 15/858,506

(22) Filed: Dec. 29, 2017

Related U.S. Application Data
(60) Provisional application No. 62/440,776, filed on Dec. 30, 2016.

(51) Int. Cl. G06Q 50/26; G06Q 10/06

(52) U.S. Cl. CPC G06Q 50/265; H04L 67/26; G06Q 10/0635

(57) ABSTRACT

A non-transitory computer readable medium includes a set of instructions that in operation cause a processor to receive an indication of a personnel threat within a predetermined distance from at least one personnel site. The instructions also cause a processor to determine whether any additional personnel sites are affected by the personnel threat, and to automatically display an indication of the personnel threat to operators of a health security platform. Further, the instructions cause a processor to initiate a risk action plan for the at least one personnel site and the additional personnel sites affected by the personnel threat, to monitor which of the personnel sites of the at least one personnel site and the additional personnel sites are in compliance with the risk action plan, and to provide alerts to the personnel sites that are not in compliance with the risk action plan.

### CROSS-REFERENCE TO RELATED APPLICATIONS

This application claims benefit and priority to U.S. Provisional Patent Application No. 62/440,776, filed on Dec. 30, 2016 entitled SYSTEMS AND METHODS FOR WEB-BASED HEALTH ALERT MANAGEMENT, the disclosure of which is incorporated by reference herein in its entirety for all purposes.

### BACKGROUND

The present disclosure relates to systems and methods that provide personnel management alerts to employers, and more specifically to web-based systems and methods that provide health and security alerts for managing personnel within an organization.

Organizations use personnel health and safety information to supplement operational decisions within the organization. For example, by receiving a notice that a health or security outbreak is occurring near a personnel site for the organization, the organization may make the decision to shut-down operations at the personnel site or to temporarily alter their organizational strategy at that personnel site based on the notice. Such notices generally occur by word of mouth alerting. Additionally, responses to the notice are generally based on printed publications that are not automatically updated in such a manner that the publications remain up to date on the most recent medical and technical advances related to dealing with personnel management alerts.

### SUMMARY

The disclosed embodiments provide systems and methods to provide personnel management alerts. In an embodiment, a non-transitory computer readable medium includes a set of instructions that in operation cause a processor to receive an indication of a personnel threat within a predetermined distance from at least one personnel site. The instructions also cause a processor to determine whether any additional personnel sites are affected by the personnel threat, and to automatically display an indication of the personnel threat to operators of a health security platform. Further, the instructions cause a processor to initiate a risk action plan for the at least one personnel site and the additional personnel sites affected by the personnel threat, to monitor which of the personnel sites of the at least one personnel site and the additional personnel sites are in compliance with the risk action plan, and to provide alerts to the personnel sites that are not in compliance with the risk action plan.

Another embodiment includes one or more storage devices storing instructions that are executable to perform operations including receiving an indication of a personnel threat and identifying personnel and personnel sites that are within a specified distance from the personnel threat. The instructions are also executable to push threat notifications to the personnel and the personnel sites that are within the specified distance from the personnel threat and to initiate a risk action plan for the personnel sites that are within the specified distance from the personnel threat.

Yet another embodiment includes a non-transitory computer readable medium including a set of instructions that in operation cause a processor to receive an indication of a personnel threat and to identify personnel and personnel sites that are within a specified distance from the personnel threat. The instructions also cause a processor to push threat notifications to the personnel and the personnel sites that are within the specified distance from the personnel threat. Further, the instructions cause a processor to monitor the personnel sites to determine if the personnel sites are in compliance with a risk action plan and to provide remedial instructions to the personnel sites that are not in compliance with the risk action plan.

Additional details of the disclosed embodiments are provided below in the detailed description and corresponding drawings.

### BRIEF DESCRIPTION OF THE DRAWINGS

Illustrative embodiments of the present invention are described in detail below with reference to the attached figures, which are incorporated by reference herein, and wherein:

FIG. 1 is a block diagram of an example of a health and security management application interacting with computing devices over a network, in accordance with an embodiment;

FIG. 2 is a representation of a global risk dashboard of the health and security management application of FIG. 1, in accordance with an embodiment;

FIG. 3 is a representation of the global risk dashboard of FIG. 2 showing locations of a health threat on a world map, in accordance with an embodiment;

FIG. 4 is a representation of a global risk dashboard after selecting a personnel site from the global risk dashboard FIG. 2, in accordance with an embodiment;

FIG. 5 is a representation of the global risk dashboard of FIG. 2 including an alert proximity tool, in accordance with an embodiment;

FIG. 6 is a flowchart of a method for activating a risk action plan, in accordance with an embodiment;

FIG. 7 is a flow chart of a method for implementing a risk action plan within a health and security management application, in accordance with an embodiment; and

FIG. 8 is a flowchart of a method for providing threat notifications to affected personnel, in accordance with an embodiment.

The illustrated figures are only exemplary and are not intended to assert or imply any limitation with regard to the environment, architecture, design, or process in which different embodiments may be implemented.

### DETAILED DESCRIPTION

In the following detailed description of several illustrative embodiments, reference is made to the accompanying drawings that form a part hereof, and in which is shown by way of illustration specific embodiments in which the invention may be practiced. These embodiments are described in sufficient detail to enable those skilled in the art to practice the invention, and it is understood that other embodiments may be utilized and that logical changes may be made without departing from the spirit or scope of the invention. To avoid detail not necessary to enable those skilled in the art to practice the embodiments described herein, the description may omit certain information known to those skilled in the art. The following detailed description is, therefore, not to be taken in a limiting sense, and the scope of the illustrative embodiments are defined only by the appended claims.

Other features and advantages of the disclosed embodiments will be or will become apparent to one of ordinary skill in the art upon examination of the following figures and detailed description. It is intended that all such additional features and advantages be included within the scope of the disclosed embodiments. Further, the illustrated figures are only exemplary and are not intended to assert or imply any limitation with regard to the environment, architecture, design, or process in which different embodiments may be implemented.

In the following discussion and in the claims, the terms “including” and “comprising” are used in an open-ended fashion, and thus should be interpreted to mean “including, but not limited to”. Unless otherwise indicated, as used throughout this document, “or” does not require mutual exclusivity.

The present disclosure relates to systems and methods that provide personnel management alerts to employers, and more specifically to web-based systems and methods that provide health alerts for managing personnel within an organization. For example, companies that are global or multi-regional may include facilities employing personnel at many different locations across the globe. Accordingly, different facilities may be exposed to or come in contact with different threats based on a geographic and/or a geopolitical location of the personnel facilities. To improve response time and efficacy of a response to such threats, a web-based application may be implemented to provide information to keep facilities and/or personnel apprised of the threats present at each location populated by the company facilities or personnel.

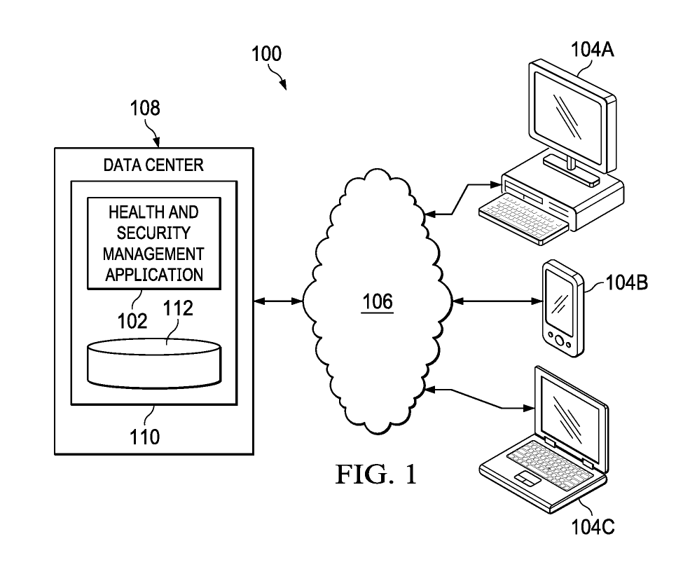

To help illustrate, FIG. 1 is a block diagram 100 of an example of a health and security management application 102 interacting with computing devices 104A-104C over a network 106. In general, the health and security management application 102 is stored within a data center 108 and accessed remotely by computing devices 104A-104C over the network 106. Accordingly, the health and security management system application 102 is updatable from a remote location, and the health and security management application 102 is able to provide alerts to users at the computing devices 104A-104C from a remote location. The data center 108 may provide a plurality of physical and/or virtual machines (VM) 110 that support applications such as the health and security management application 102. The VM 110 and/or the data center 108 may also provide storage 112 to hold application data, customer data, order information, or any other data that may be used by the health and security management application 102.

Users, such as management teams from multi-regional companies, access the health and security management application 102 by connecting to the data center 108 over the network 106 using the computing devices 104A-104C. The network 106 may be, for example, one or more of the Internet, an intranet, a Local Area Network (LAN), a wireless Local Area Network (WLAN), a wireless data network, or any other network that is able to communicatively connect the computing devices 104A-104C to the data center 108. The computing devices 104A-104C may include, for example, desktops, notebooks, or tablet computers, smartphones, personal digital assistants (PDAs), or any other computing devices capable of connecting to the network 106 and receiving information from the data center 108. In an embodiment, the users access the health and security management application 102 using a web browser on computing devices 104A-104C. In other embodiments, a health and security management application program or Graphical User Interface (GUI) of a native application running on the computing devices 104A-104C may be used to access the health and security management application 102.

In an embodiment, users of the health and security management application 102 may use the health and security management application 102 to monitor statuses of personnel locations of a company as they relate to threats facing the personnel locations. Further, users may receive from the health and security management application 102 real-time alerts of threats associated with personnel locations, risk action plans to address the threats, and/or literature discussing a threat. The health and security management application 102 may monitor reactions of the personnel locations to threat indications provided by the health and security management application 102.

In response to a non-compliant response, the health and security management application 102 may send a notice of non-compliance to the personnel locations that do not react in accordance with a risk action plan. Additionally, the health and security management application 102 may provide remedial instructions to the personnel locations that are not in compliance with the risk action plan. The remedial instructions may be steps that the personnel locations may take to resolve any issues resulting from the personnel site not initially acting in compliance with the risk action plan.

Further, the computing devices 104A-104C may be used by an administrator of the health and security management application 102 to update or otherwise alter the functionality or content of the health and security management application 102 over the network 106. Accordingly, the health and security management application 102 is updatable from a location that is remote from the data center 108. In another embodiment, an additional computing device may be located in the data center 108 that is able to update health and security management application 102 locally from the data center 108.

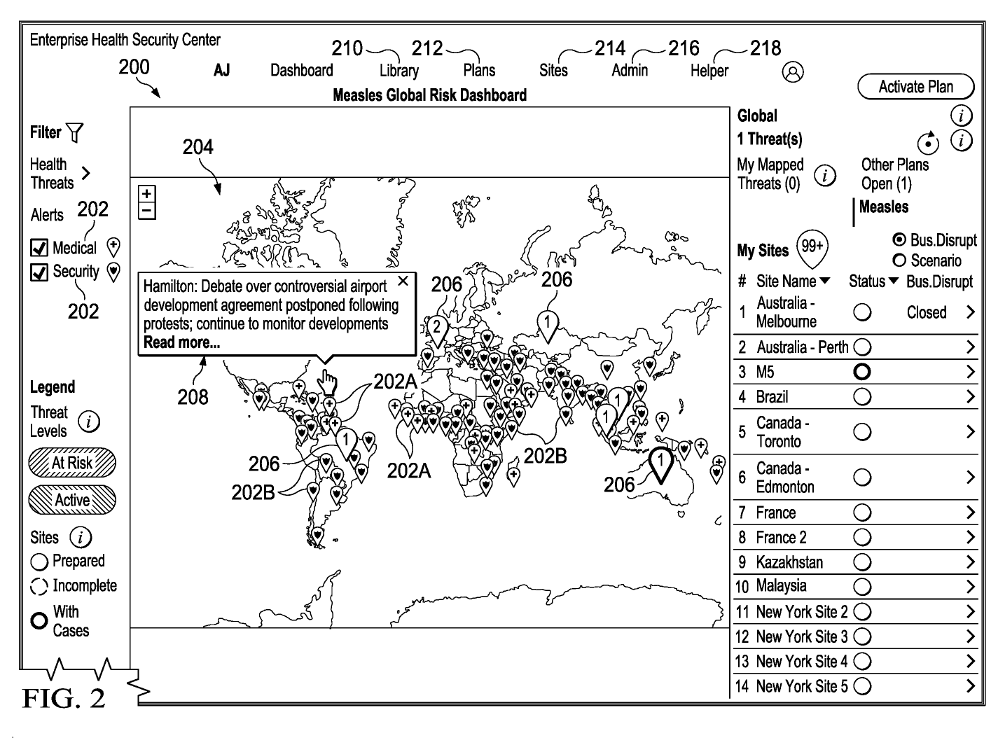

Turning to FIG. 2, a global risk dashboard 200 of the health and security management application 102 is illustrated. The global risk dashboard 200 operates as a central hub for monitoring global alerts 202 associated with health and safety, as well as a platform for viewing and interacting with responses to the global alerts 202 that appear on the global risk dashboard 200. As an example, a world map 204 prominently displayed on the global risk dashboard 200 is capable of providing both an indication to a user of medical alerts 202A and security alerts 202B, and the world map 204 is also capable of providing an indication of personnel sites 206 where an organization has personnel. The global alerts 202 may include alerts relating to pandemics, terrorist attacks, natural disasters, or any other threats that a company may wish to respond to with plans to minimize risk associated with the threats (e.g., a risk action plan).

Additionally, FIG. 2 provides an indication of which of the sites 206 have prepared risk action plans, which of the sites 206 have incomplete risk action plans, and which of the sites 206 have active cases. Each of these scenarios are indicated by different shadings of pins that are used to represent locations of the sites 206. For example, a red shading of a pin representing a site 206 may indicate that the site 206 has an active alert 202, a green shading of the pin representing the site 206 may indicate that the site 206 has a completed risk action plan but no active alert 202, and a gray shading of the pin representing the site 206 may indicate that the site 206 has an incomplete risk action plan and no active alert 202.

The sites 206 with active cases may also provide indications of specific alerts 202 that are active in the vicinity of a displayed site 206. For example, when a specific alert 202 is selected with a mouse click, an information bubble 208 is populated on the global risk dashboard 200 to provide an indication of specific details of the specific alert 202. Additionally, the global risk dashboard provides a user access to a dynamically searchable library 210, stored risk action plans 212, a listing 214 of sites 206 that include personnel of the organization, an administration portal 216, and a helper portal 218.

Also illustrated in FIG. 2 are medical alerts 202A displayed on the world map 204. The displayed medical alerts 202A provide a user of the global risk dashboard 200 an indication of where active medical alerts 202A are located across the globe. This includes medical alerts 202A in locations that do not include organizational sites 206. For example, an organization may want to provide an employee with information related to a medical alert 202A when the employee is traveling to a location currently under the medical alert 202A even when the organization does not have a site 206 that permanently employs personnel in the location. The medical alerts 202A are displayed on the world map 204 as a pin with a Greek cross. When a user selects a medical alert 202A (e.g., via a mouse click), an information bubble similar to the information bubble 208, described above, will provide an indication of what specific medical alert (e.g., a pandemic threat) is represented by the medical alert indication.

The addition of the security alerts 202B to the medical alerts provides the user of the global risk dashboard 200 an indication of where active security alerts 202B are located across the globe. As with the medical alerts 202A, this includes security alerts 202B in locations that do not include organizational sites 206. For example, an organization may want to provide an employee with information related to security alerts 202B when the employee is traveling to a location where security is a concern even when the organization does not have a site 206 that permanently employs personnel in the location. The security alert 202B indications are displayed on the world map as a pin with a shield. When a user selects a security alert indication (e.g., via a mouse click), the information bubble 208 will appear to provide an indication of what is represented by the security alert 202B.

The dynamically searchable library 210 of the health and security management application 102 may be accessed from the global risk dashboard 200. The dynamically searchable library 210 provides a user of the health and security management application 102 with access to resources related to the medical and security alerts 202 of the health and security management application 102. A user is able to search the dynamically searchable library 210 by keyword, or filter the resources of the dynamic library by specific threat alerts 202. Additionally, a user is able to filter the resources by resource type. Moreover, the resources may be periodically updated by an administrator of the health and security management application 102 to maintain current information for users of the health and security management application 102. Resources included in the dynamically searchable library 210 include content (e.g., communication tools, posters, academic literature, etc.) related to pandemics, terrorist attacks, natural disasters, or any other threats that a personnel site 206 may experience.

Also included in the dynamically searchable library 210 is the ability to add to or edit the resources provided by the health and security management application 102. For example, an organization may have pre-existing resources related to specific health or security alerts 202 that the organization frequently encounters. Providing the user the ability to add such existing resources to the dynamically searchable library 210 allows the user to merge previous plans to respond to threats with the risk action plans provided by the health and security management application 210.

In an embodiment, the health and security management application 102 is a subscription service with varying subscription levels available to an organization. By way of example, the organization may subscribe to a number of sites 206 available to the organization for monitoring (e.g., the subscription may allow for a maximum of 200 total monitored personnel sites 206), and the organization may subscribe to specific sets of health and security alerts 202 (e.g., only the health alerts 202A, only the security alerts 202B, sub-combinations of the health or security alerts 202A and 202B, or any combination thereof). Further, the organization may subscribe to only the health alerts 202A or the security alerts 202B that affect personnel sites 206 of the organization. For example, a company primarily located in Northern locations may not be as concerned about tropical diseases as a company that operates near the equator. Similarly, an organization in San Francisco may subscribe to earthquake alerts while not subscribing to tornado alerts.

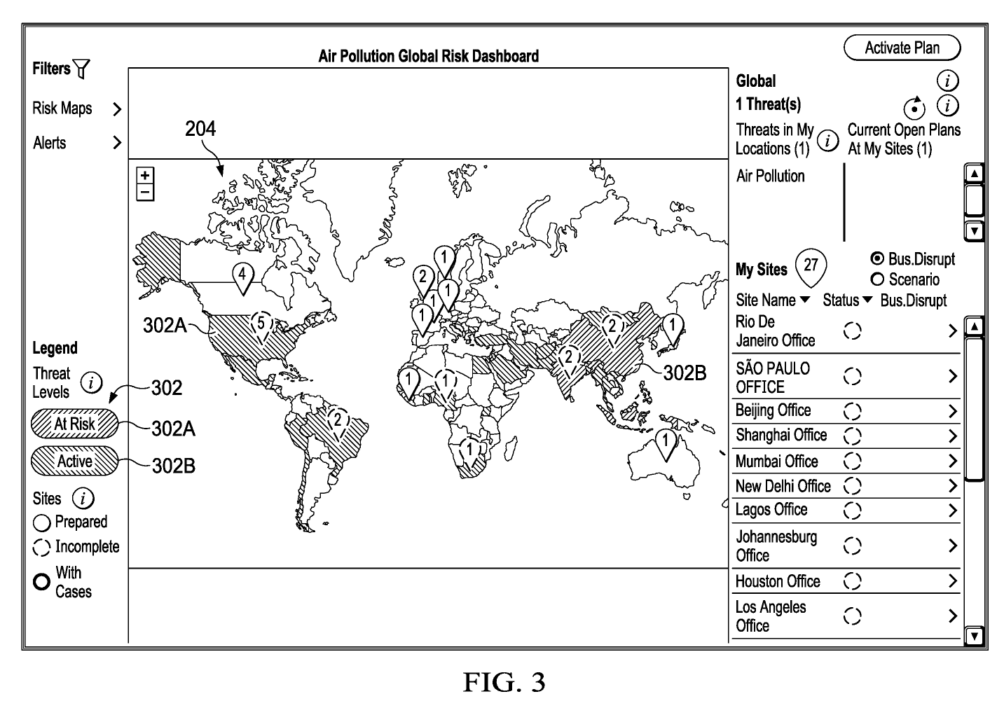

FIG. 3 is an illustration of the global risk dashboard 200 showing locations of a health threat on the world map 204. While interacting with the global risk dashboard 200, a user may select a specific health threat that is viewable on the world map. As indicated in a legend 302, threat levels are illustrated at three different levels. For example, a “no threat” level of a specific health threat would have standard world map shading based on geographic features, an “at-risk threat” level 302A would have a lightly shaded region, and an “active threat” level 302B would have a darker shaded region than the “at-risk” level.

In the illustrated embodiment of FIG. 3, the specific health threat selected by a user is air pollution, and the at-risk threat levels 302A and the active threat levels 302B are illustrated with shading intensity as indicated in the legend 302. The threat levels 302A and 302B, in an embodiment, may be determined and updated by an alert center for the health and security management application 102. By way of example, the alert center may monitor news and reports provided by health organizations and the media for indications of the health threats that may be indicated by the health and security management application 102. Upon detection of “at-risk” or “active” health threats 302A or 302B, the alert center updates the word map 204 with the appropriate threat level indicators.

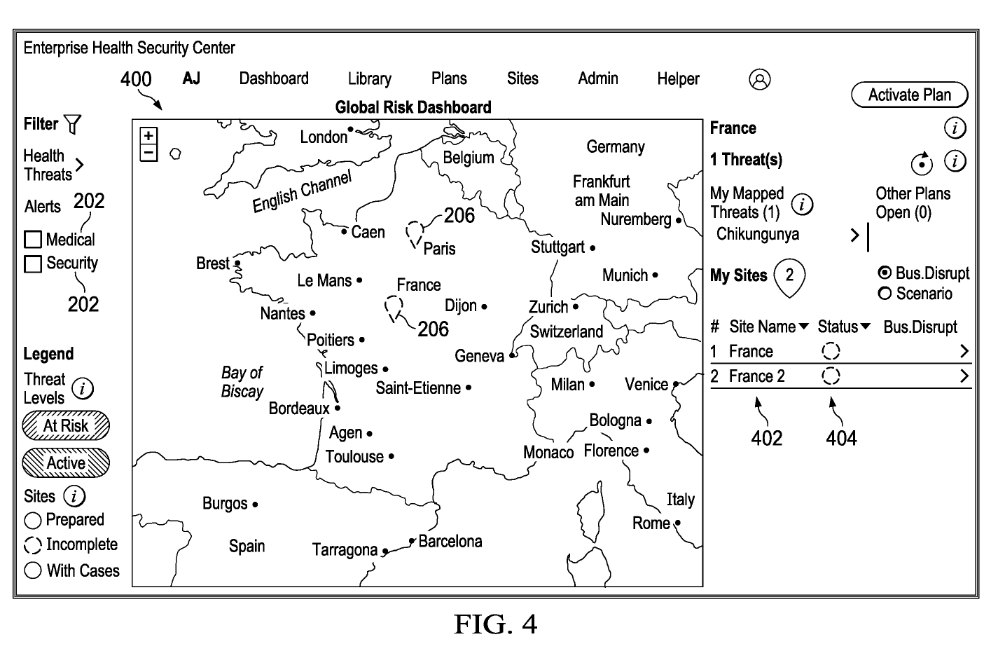

FIG. 4 is a global risk dashboard 400 resulting from selecting a personnel site 206 of an organization from the global risk dashboard 200 of FIG. 2. When a user of the health and security management application 102 selects a specific site pin 206 on the world map 204, the global risk dashboard 200 automatically enlarges a region surrounding the location of the selected personnel site 206 of the organization. In the illustrated embodiment, a personnel site 206 in France was selected, and the world map 204 enlarged the region surrounding France to generate the global risk dashboard 400 illustrated in FIG. 4. By enlarging the region surrounding the selected personnel site 206, a user is able easily select between locations that are closer together on a map showing a larger portion of the world, or the user is able to view a more detailed presentation of the alerts 202 in a region of particular concern to the user.

The selected site 206 in France is depicted as a single site 206 in the global risk dashboard 200 of FIG. 2, but the selected site 206 includes two personnel sites 206A and 206B of the organization, as illustrated in the global risk dashboard 400. When a selected country or region has multiple personnel sites 206 in close proximity, each of the personnel sites are displayed when the country or region is selected from the global risk dashboard 200. Additionally, as illustrated, the pins representing the two French personnel sites 206 provide an indication to a user of the completeness of a risk action plan. Each of the French personnel sites 206A and 206B include incomplete risk action plans, as illustrated by the light shading of the pins. Providing this indication to the user functions as a prompt to the user to complete the risk action plans to be fully compliant for a subsequent health or security threat to the two personnel sites 206A and 206B.

It may be appreciated that even when an organization has personnel sites 206A and 206B near one another, each of the personnel sites 206A and 206B may maintain risk action plans completely separate from one another. For example, the personnel site 206A may be a location that is predominantly an office setting, while the personnel site 206B may be a warehouse or manufacturing facility. Because each of the locations include different personnel numbers, different equipment that is addressed during a threat, or other factors that differ and may influence creation of separate risk action plans, the facilities may operate separately during a risk action plan to minimize the effects of the threat in the individual personnel sites 206A and 206B.

When a site 206 is selected from a “My Sites” list 402, a site view of a specific personnel site 206 of an organization may be presented to the user of the health and security management application 102. In the site view of the selected personnel site 206, a user is able to view an exact location of the personnel site, information about the site management, an indication of the nearest hospital, and an indication of a public health authority, in addition to other details. The site view may also provide information concerning risk action plans at the personnel site 206 for various health and security alerts 202. In an embodiment, a user may select a specific alert 202 in the global risk dashboard 200/400, such as a specific disease. After selecting the specific alert 202, the world map 204 provides an indication of the threat levels 302 of the specific alert 202 across the world map, as shown in FIG. 3, and the risk action plan statuses 404 of the personnel sites 206 in relation to the specific alert 202. Further, other details may be provided in relation to the risk action plan. In an embodiment, the site view may also indicate suspected and/or confirmed cases at the personnel site 206 associated with the site view.

The site view may also provide a mechanism, such as an activation link or user interaction element, that enables the user of the health and security management application 102 to activate a risk action plan. In an embodiments, the health and security management application 102 may also automatically activate the risk action plan based on the threat level 302 within the region of the personnel site 206. For example, when the threat level 302 is “at-risk” or “active,” the health and security management application 102 automatically activates the risk action plan associated with the alert 202 and notifies a site manager and a risk action plan manager of the activation. As used herein, the risk action plan may be a document and/or a series of instructions for a specific personnel site 206 to address an active health or security alert 202. The risk action plan may also include automated functionalities such as pushing notifications to personnel that are in any way affected by the active health or security alert 202. The risk action plan may be edited by an authorized user for site specific personalization.

Further, the risk action plans may differ from other risk actions plans within an organization that address the same health or security alert 202. For example, the risk action plan for measles in the United States may differ significantly from a risk action plan for measles in China based on local health concerns as well as social and economic realities of a region. Other factors may also impact variations of the risk action plans between the personnel sites 206.

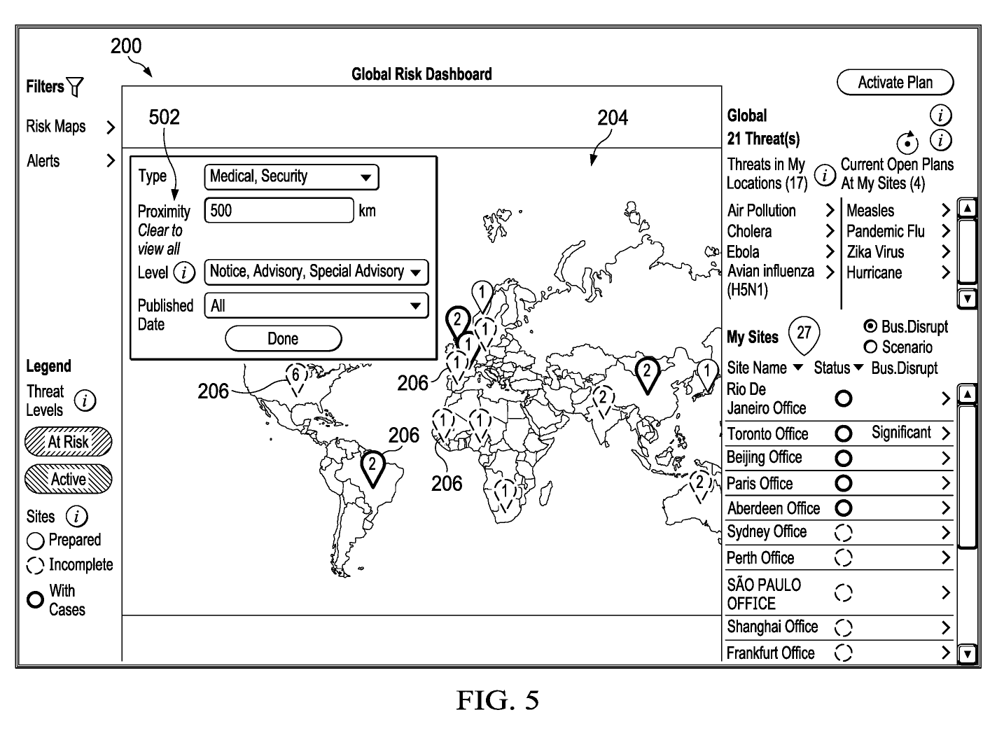

FIG. 5 is a view of the global risk dashboard 200 including an alert proximity tool 502. The alert proximity tool 502 enables a user of the health and security management application 102 to hone in on health and security alerts 202 within a specified distance from a personnel site 206. When a distance is entered, the world map 204 is able to populate only the health and security alerts 202 within the specified proximity of an organization's personnel sites 206. Accordingly, visualization of alerts 202 that do not have an impact on personnel of a company or organization is avoided.

In an embodiment, the personnel of a company may all be equipped with global positioning monitoring devices, such as through a cellular telephones or other computing devices 104. In such an embodiment, the alert proximity tool 502 may provide health alerts 202 within the proximity of the personnel of the company in addition to the personnel sites 206. By way of example, an employee traveling to a country that does not include a personnel site 206 may trigger the population of health and security alerts 202 within 500 km of the location within the country in which the employee is traveling.

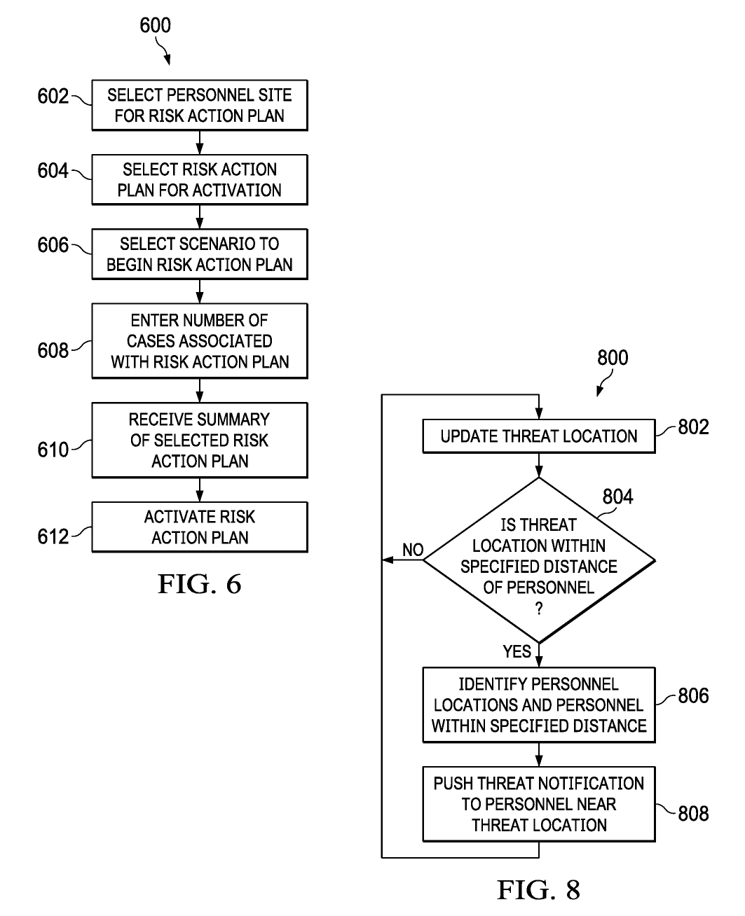

Turning to FIG. 6, a flowchart of a method 600 for activating a risk action plan is illustrated. Initially, at block 602, a user of the health and security management application 102 selects the personnel site 206 at which the user wants the risk action plan to be activated. The user may perform the personnel site selection either through a search prompt within the health and security management application 102 or by selecting a personnel site 206 from a site list displayed within the health and security management application 102.

At block 604, a user selects a specific risk action plan for the selected personnel site 206 that the user wants activated. The health and security management application 102 may provide a user with a list of plans that are selectable for the selected personnel site 206. The available risk action plans may be limited to risk action plans associated with a current health or security alert 202 or to risk action plans within a subscription profile of a subscribing organization.

Subsequently, at block 606, a user selects a scenario in which the risk action plan begins. For example, a list of scenarios may be provided to the user in the health and security management application 102, and the user is able to select from the list of scenarios based on which of the scenarios on the list most closely align with the present real-world scenario. The different beginning scenarios may change tasks in the risk action plan being implemented. For example, when an organization is already has personnel with confirmed cases of influenza, the risk action plan may be slightly different from a scenario where the organization is made aware of local cases of influenza but there are no confirmed cases within the personnel of the organization.

At block 608, a user enters a number of on-site cases of the health or security alert 202 associated with the selected risk action plan. In an embodiment, entries at block 608 may only be prompted when, at block 606, the user indicates that on-site cases of the health or security alert 202 are confirmed. For example, block 608 prompts a user to enter an exact number of known or suspected cases of a health or security alert 202 at the specific personnel site 206 associated with the risk action plan being implemented.

Block 610 provides a user with a plan overview for the risk action plan that is populated based on the other blocks in the method 600. For example, a user may receive a summary of the entries previously entered in relation to blocks 602-608. The user may also receive an option in the health and security management application 102 to activate the risk action plan as a “Test Plan.” In an embodiment, a test plan may be run periodically for an organization to maintain compliance with insurance requirements, to maintain compliance with governmental requirements, to maintain compliance with any other entity requirements, or any combination thereof. When the user determines that the plan overview is satisfactory for the present scenario, a user activates the risk action plan at block 612 in either a standard mode or a test mode.

The risk action plan resulting from the method 600 may include an indication of the current scenario under which the risk action plan is operating, an indication of a percentage of completion of the risk action plan tasks, details about administration of the risk action plan, and other information related to the activated risk action plan. In an embodiment, the risk action plan operates as a portal in the health and security management application 102. The presence of the risk action plan in the health and security management application 102 allows for users with access to the risk action plan to update indications that risk action plan tasks have been completed, and also allows users to access resources related to the risk action plan.

The risk action plan may also include a task list. The task list may include a list of tasks that are to be completed, an indication of who is assigned to completing each task (e.g., an owner of the task), an indication of the current status of each task, an indication of the priority of each task, an indication of a time constraint of each task, and an indication of a cost constraint to complete each task. As each task of the risk action plan is completed, the owner of each task may update risk action plan in the health and security management application 102 to provide an indication that the task is complete.

As part of the risk action plan, resources related to the health and security alerts 202 may be linked to tasks or situation summaries in the risk action plan. The resource links enable a user to quickly find information related to a specific task of the risk action plan of the specified health or security alert 202 or information encompassing the entire specified health or security alert 202. For example, the risk action plan may include a “View Resources” button that provides a listing of resources related to business continuity during a threat of the spread of Zika virus. Different groups of resources may be presented to the user when the user selects the “View Resources” buttons for different categories of risk action plan tasks.

Further, documents related to the risk action plan or the linked resources may be automatically generated by the health and security management application 102 for distribution to personnel. The generated document is printable, is able to be saved, and a user has the ability to share the generated document, via e-mail or other electronic systems, with parties that may be interested in the progress of the risk action plan. A user may e-mail the generated document directly through the health and security management application 102 to any parties that might desire access to the document, or would benefit from access to the document, but do not have access to the health and security management application 102. In this manner, a large personnel team may remain up-to-date about the progress of activating the risk action plan without having to provide the entirety of the large personnel team with access to the health and security management application 102.

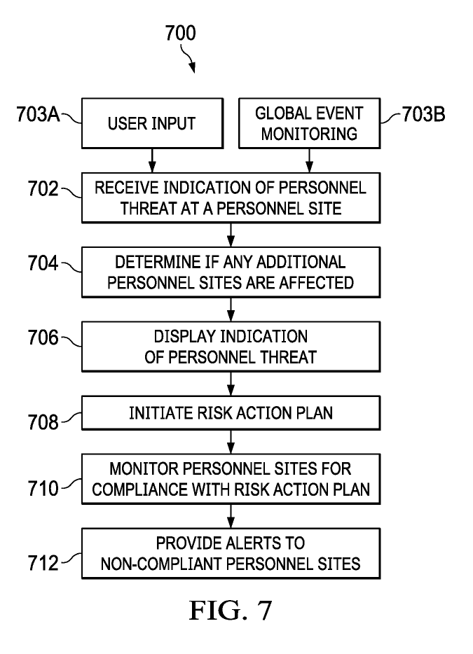

FIG. 7 is a flow chart of a method 700 implementing a risk action plan within the health and security management application 102. At block 702, the health and security management application 102 receives an indication of a personnel threat at a personnel site 206. The indication may be received from an operator monitoring health organization and news feeds (e.g., block 703A), the indication may be received from an individual located at the personnel site with firsthand knowledge of the situation (e.g., block 703A), or the indication may be generated by the health and security management application 102 from an automated scan of news sources originating in a location near the personnel site (e.g., block 703B). An automated scan of block 703B may also be accomplished by receiving local data from hospitals, prisons, police and fire stations, or any other data sources that are able to provide data to the health and security management application 102. Once the data is received from the data sources by way of block 703B, the health and security management application 102 may run the data through an automated process to scan for keywords relating to health and safety threats 202 covered by a subscription of an organization to the health and security management application 102.

At block 704, the health and security management application 102 determines if any additional personnel sites are affected beyond the original personnel site indicated at block 702. This may be accomplished by directing a search of health organization alerts and news feeds from around the world using keywords related to the original personnel threat. Such a search may be accomplished manually by a user or through an automated keyword search of data in additional locations performed in a similar manner to the data search at block 702.

At block 706, the health and security management application 102 displays an indication of the determined personnel threats on the world map 204 of the global risk dashboard 200 as health or security alerts 202. As discussed above with reference to FIG. 3, the world map 204 may display the health or security alerts 202 at three different threat levels: none, at-risk, and active. Further, the use of additional threat levels to cover varying scenarios is also contemplated by the presently disclosed subject matter. For example, more or fewer threat levels than the three threat levels illustrated in the figures above may be included in varying embodiments of the health and security management application 102.

At block 708, the health and security management application 102 initiates a risk action plan in response to the personnel threat at the personnel site(s) 206. As discussed above, the health and security management application 102 may initiate the risk action plan based on direct input from a user, or the health and security management application 102 may automatically initiate the risk action plans based on known information related to the personnel threat.

At block 710, the health and security management application 102 monitors the personnel sites 206 with initiated risk action plans for compliance with the risk action plans. For example, when the risk action plan is initiated, a series of tasks are provided to the users of the health and security management application 102. The health and security management application 102 may monitor the completion of these tasks to ensure that the organization is responding to a personnel threat effectively.

At block 712, the health and security management application 102 provides alerts to non-compliant personnel sites 206. The alerts may come in the form of indicating to a user within the health and security management application 102 that risk action plans are incomplete. Additionally or alternatively, the health and security management application 102 may automatically generate an e-mail or other electronic alert notice, and send the e-mail to the administrators of the health and security management application 102 indicating non-compliance with the risk action plan. The alerts to the personnel sites 206 not in compliance with the risk action plan may also include an indication of remedial steps for the personnel site 206 to take to become compliant with the risk action plan.

Turning to FIG. 8, a flowchart of a method 800 for providing threat notifications to affected personnel is illustrated. Initially, at block 802, a threat location is updated in the health and security management application 102. The threat location may be identified on the world map 204 as a health or security alert 202.

To identify health and/or safety threats that may have an effect on a personnel site 206 of an organization, the health and security management application 102 may determine if a threat location is within a specified distance of organization personnel at block 804. By way of example, the determination may be made based on locations of the personnel sites 206 in relation to the location of the health and/or safety threat, the determination may be made based on locations of actual personnel in relation to the location of the health and/or safety threat, or the determination may be made based on a combination thereof. Further, a user of the health and security management application 102 may set the specified distance from a health or security alert 202 within which personnel and personnel sites 206 are identified. A user may specify individual distances for different health or security alerts 202 based on how significant a health or security alerts 202 may be to personnel at varying distances from the health or security alerts 202. In another embodiment, the health and security management application 102 may automatically assign the distances for the health or safety threats based on the specific type of health or safety threat. If no personnel is located within the specified distances of the health or security alert 202, additional threat locations are updated at block 802 and the method 800 restarts.

At block 806, the personnel locations 206 and the personnel that are within the specified distance of block 804 are identified. By way of example, the personnel locations 206 are generally static, so a simple measurement between the static personnel location 206 and the health or security alert 202 may be used to identify which of the static personnel locations 206 are within the specified distance. In contrast, individual personnel or groups of personnel may generally move from area to area independent from the static personnel locations 206. To identify the personnel or groups of personnel that are within the specified distance of the health or security alert 202, the health and security management application 102 may have access to global positioning systems associated with the computing devices 104 controlled by the personnel. In this manner, the health and security management application 102 is able to maintain accurate data about personnel and groups of personnel that may be affected by health or security alerts 202.

Once personnel locations 206 and the personnel or personnel groups within the specified distance of the health or security alerts 202 are identified, the health and security management application 102 may push notifications to the parties that are within the specified distance of the health or security alerts 202. The notifications may be pushed to both the health and security management application 102 on the computing device 104 of the personnel, an e-mail address of affected personnel, through a telephone service of the affected personnel, or any other method of communication capable of providing a notification to the affected personnel. Once the affected personnel has been notified, or upon receiving a new threat location, the health and security management application 102 may be updated for any new threats at block 802.

The above-disclosed embodiments have been presented for purposes of illustration and to enable one of ordinary skill in the art to practice the disclosure, but the disclosure is not intended to be exhaustive or limited to the forms disclosed. Many insubstantial modifications and variations will be apparent to those of ordinary skill in the art without departing from the scope and spirit of the disclosure. For instance, although the flowcharts depict serial processes, some of the steps/processes may be performed in parallel or out of sequence, or combined into a single step/process.

While this specification provides specific details related to web-based health and security management systems, it may be appreciated that the list of components is illustrative only and is not intended to be exhaustive or limited to the forms disclosed. Other components related to managing health alerts will be apparent to those of ordinary skill in the art without departing from the scope and spirit of the disclosure. Further, the scope of the claims is intended to broadly cover the disclosed components and any such components that are apparent to those of ordinary skill in the art.

It should be apparent from the foregoing disclosure of illustrative embodiments that significant advantages have been provided. The illustrative embodiments are not limited solely to the descriptions and illustrations included herein and are instead capable of various changes and modifications without departing from the spirit of the disclosure.

What is claimed is:

1. A non-transitory computer readable medium comprising a set of instructions that in operation cause a processor to:
receive an indication of a personnel threat within a predetermined distance from at least one personnel site;
determine whether any additional personnel sites are affected by the personnel threat;
automatically display an indication of the personnel threat to operators of a health security platform;
initiate a risk action plan for the at least one personnel site and the additional personnel sites affected by the personnel threat;
monitor which of the personnel sites of the at least one personnel site and the additional personnel sites are in compliance with the risk action plan; and
provide alerts to the personnel sites that are not in compliance with the risk action plan.

2. The computer readable medium of claim 1, wherein the personnel threat comprises a personnel health threat.

3. The computer readable medium of claim 1, wherein the personnel threat comprises a personnel security threat.

4. The computer readable medium of claim 1, wherein the risk action plan includes providing resources to personnel at the at least one personnel site, the resources related to the personnel threat.

5. The computer readable medium of claim 1, wherein the alerts provided to the personnel sites that are not in compliance with the risk action plan comprise an indication of steps for the personnel sites that are not in compliance with the risk action plan to become in compliance with the risk action plan.

6. The computer readable medium of claim 1, wherein the set of instructions cause the processor to:
receive an indication as to whether the at least one personnel site and the additional personnel sites affected by the personnel threat have purchased access to the risk action plans for the personnel threat; and
initiate the risk action plan at the at least one personnel site and the additional personnel sites only when the at least one personnel site and the additional personnel sites have purchased the risk action plans for the personnel threat.

7. The computer readable medium of claim 1, wherein the risk action plan of each of the personnel sites is at least in part determined from receiving a personnel site specific entry regarding a threat scenario of the personnel threat at each of the personnel sites.

8. The computer readable medium of claim 1, wherein the risk action plan varies based on a threat scenario of the personnel threat.

9. The computer readable medium of claim 1, wherein initiating the risk action plan comprises displaying a set of tasks for completion by the at least one personnel site and the additional personnel sites affected by the personnel threat.

10. The computer readable medium of claim 1, wherein the personnel sites not in compliance with the risk action plan comprises the personnel sites that have incomplete risk action plans.

11. One or more storage devices storing instructions that are executable to perform operations comprising:
receiving an indication of a personnel threat;
identifying personnel and personnel sites that are within a specified distance from the personnel threat;
pushing threat notifications to the personnel and the personnel sites that are within the specified distance from the personnel threat; and
initiating a risk action plan for the personnel sites that are within the specified distance from the personnel threat.

12. The one or more storage devices of claim 11 storing instructions that are executable to perform operations comprising:
monitoring which of the personnel sites are in compliance with the risk action plan; and
providing alerts to the personnel sites that are not in compliance with the risk action plan.

13. The one or more storage devices of claim 11, wherein the specified distance is determined based on the personnel threat.

14. The one or more storage devices of claim 11, wherein the risk action plan includes providing resources to the personnel and the personnel sites related to the personnel threat.

15. The one or more storage devices of claim 11 storing instructions that are executable to perform operations comprising:
receiving a personnel site specific entry regarding a threat scenario of the personnel threat at each of the personnel sites within the specified distance; and
initiating the risk action plan for the personnel sites based on the received threat scenario.

16. A non-transitory computer readable medium comprising a set of instructions that in operation cause a processor to:
receive an indication of a personnel threat;
identify personnel and personnel sites that are within a specified distance from the personnel threat;
push threat notifications to the personnel and the personnel sites that are within the specified distance from the personnel threat;
monitor the personnel sites to determine if the personnel sites are in compliance with a risk action plan; and
provide remedial instructions to the personnel sites that are not in compliance with the risk action plan.

17. The computer readable medium of claim 16, wherein the risk action plan is customizable to a corresponding personnel site.

18. The computer readable medium of claim 16, wherein receiving the indication of the personnel threat comprises automatically scanning data for keywords associated with the personnel threat.

19. The computer readable medium of claim 18, wherein the data is received from hospitals, prisons, police and fire stations, or any combination thereof.

20. The computer readable medium of claim 16, wherein pushing the threat notifications to the personnel and the personnel sites is performed automatically upon identifying the personnel and the personnel sites that are within the specified distance from the personnel threat.
